(19) United States
(12) Patent Application Publication
(10) Pub. No.: US 2025/0193932 A1
(43) Pub. Date: Jun. 12, 2025

(54) SYSTEM AND METHOD FOR WIRELESS COMMUNICATIONS

(71) Applicant: NXP USA, Inc., AUSTIN, TX (US)

(72) Inventors: Liwen Chu, San Ramon, CA (US); Kiseon Ryu, San Diego, CA (US); Huizhao Wang, San Jose, CA (US); Ken Kinwah Ho, San Jose, CA (US); Hongyuan Zhang, Fremont, CA (US)

(21) Appl. No.: 18/962,231

(22) Filed: Nov. 27, 2024

Related U.S. Application Data
(60) Provisional application No. 63/568,605, filed on Mar. 22, 2024.
(60) Provisional application No. 63/626,731, filed on Jan. 30, 2024.
(60) Provisional application No. 63/607,343, filed on Dec. 7, 2023.

(51) Int. Cl. H04W 74/0816; H04W 28/02; H04W 74/00

(52) U.S. Cl. CPC H04W 74/0816; H04W 28/0278; H04W 74/002

(57) ABSTRACT

Embodiments of a method and apparatus for communications are disclosed. In an embodiment, a wireless device includes a controller configured to determine an arrangement of control information and a wireless transceiver configured to announce the arrangement of the control information in a first frame exchange with a second wireless device in a transmit opportunity (TXOP) and to conduct subsequent frame exchanges with the second wireless device based on the arrangement of the control information.

### CROSS-REFERENCE TO RELATED APPLICATIONS

This application is entitled to the benefit of U.S. Provisional Patent Application Ser. No. 63/607,343, filed on Dec. 7, 2023, U.S. Provisional Patent Application Ser. No. 63/626,731, filed on Jan. 30, 2024, and U.S. Provisional Patent Application Ser. No. 63/568,605, filed on Mar. 22, 2024, the contents of which are incorporated by reference herein.

### BACKGROUND

Wireless communications devices, e.g., access points (APs) or non-AP devices can transmit various types of information using different transmission techniques. For example, various applications, such as, Internet of Things (IoT) applications can conduct wireless local area network (WLAN) communications, for example, based on Institute of Electrical and Electronics Engineers (IEEE) 802.11 family of standards (e.g., Wi-Fi standards). In multi-link communications, an access point (AP) multi-link device (MLD) may wirelessly transmit data to one or more wireless stations in a non-AP MLD through one or more wireless communications links. Some applications, for example, video teleconferencing, streaming entertainment, high definition (HD) video surveillance applications, outdoor video sharing applications, etc., require relatively high system throughput.

### SUMMARY

Embodiments of a method and apparatus for communications are disclosed. In an embodiment, a wireless device includes a controller configured to determine an arrangement of control information and a wireless transceiver configured to announce the arrangement of the control information in a first frame exchange with a second wireless device in a transmit opportunity (TXOP) and to conduct subsequent frame exchanges with the second wireless device based on the arrangement of the control information. Other embodiments are also disclosed.

In an embodiment, the arrangement of the control information includes at least one of in-device interference information, power saving information, sub-band switch information, and per TXOP responder's transmitter/receiver (Tx/Rx) parameter negotiation information for the TXOP.

In an embodiment, per TXOP responder's transmitter/receiver (Tx/Rx) parameters for different TXOP responders are different.

In an embodiment, the controller is further configured to generate an initiating control frame that includes the arrangement of the control information.

In an embodiment, the arrangement of the control information includes a control information triple, and the control information triple includes type information, length information, and content information.

In an embodiment, the arrangement of the control information includes a control information pair, and the control information pair includes type information and content information.

In an embodiment, the wireless transceiver is further configured to receive a second arrangement of the control information from the second wireless device in the first frame exchange with the second wireless device in the TXOP and conduct the subsequent frame exchanges with the second wireless device in the TXOP based on the arrangement of the control information and the second arrangement of the control information.

In an embodiment, the controller is further configured to generate an initiating control frame that contains the arrangement of the control information, and the wireless transceiver is further configured to receive, from the second wireless device, a responding control frame that contains the second arrangement of the control information.

In an embodiment, the initiating control frame includes a Buffer Status Report Poll (BSRP) trigger frame, and the responding control frame includes a multi-station (multi-STA) block acknowledgement (BA) frame.

In an embodiment, the BSRP trigger frame contains information that indicates whether the Multi-STA BA frame is contained in a non-High Throughput (HT) Physical Layer Protocol Data Unit (PPDU) when the BSRP trigger frame solicits the Multi-STA BA frame from a single recipient.

In an embodiment, the Multi-STA BA frame does not carry a BA bitmap for acknowledging an Aggregate MAC Protocol Data Unit (A-MPDU).

In an embodiment, the Multi-STA BA frame includes a Per Association ID (AID) Traffic Identifier (TID) information (Info) field for all addressed or associated stations (STAs).

In an embodiment, the initiating control frame includes a block acknowledgement response (BAR) frame, and the responding control frame includes a block acknowledgement (BA) frame.

In an embodiment, the initiating control frame includes a multi-user-request to send (MU-RTS) frame, the responding control frame includes a clear to send (CTS) frame, and a TXOP holder of the TXOP does not send feedback information.

In an embodiment, the initiating control frame includes a Buffer Status Report Poll (BSRP) trigger frame, the responding control frame includes a quality of service (QOS) null frame, and a TXOP holder of the TXOP does not send feedback information.

In an embodiment, the wireless transceiver is further configured to transmit the initiating control frame to the second wireless device.

In an embodiment, the initiating control frame includes a special User information (Info) field for all addressed or associated stations (STAs).

In an embodiment, the wireless device includes a mobile wireless access point (AP) or a wireless non-AP station (STA).

In an embodiment, a wireless access point (AP) compatible with an Institute of Electrical and Electronics Engineers (IEEE) 802.11 protocol includes a controller configured to determine an arrangement of control information and a wireless transceiver configured to announce the arrangement of the control information in a first frame exchange with a wireless station (STA) device in a transmit opportunity (TXOP) and to conduct subsequent frame exchanges with the wireless STA device in the TXOP based on the arrangement of the control information.

In an embodiment, a method for wireless communications involves announcing arrangements of control information in a first frame exchange between a first wireless device and a second wireless device in a transmit opportunity (TXOP), where each of the arrangements of the control information includes at least one of in-device interference information, power saving information, sub-band switch information, and per TXOP responder's transmitter/receiver (Tx/Rx) parameter negotiation information for the TXOP, and conducting subsequent frame exchanges between the first wireless device and the second wireless device in the TXOP based on the arrangements of the dynamic control information.

Other aspects in accordance with the invention will become apparent from the following detailed description, taken in conjunction with the accompanying drawings, illustrated by way of example of the principles of the invention.

### BRIEF DESCRIPTION OF THE DRAWINGS

FIG. 1 depicts a wireless communications system in accordance with an embodiment of the invention.

FIG. 2 depicts a multi-link (ML) communications system that is used for wireless communications in accordance with an embodiment of the invention.

FIG. 3 depicts a wireless device in accordance with an embodiment of the invention.

FIG. 4 depicts a wireless device with multiple wireless transceivers in accordance with an embodiment of the invention.

FIG. 5 shows a swim-lane diagram illustrating an example of frame exchanges between a TXOP holder and a TXOP responder.

FIG. 6 illustrates a frame format in accordance with an embodiment of the invention.

FIG. 7 illustrates a Dynamic Control Per Association ID (AID) Traffic Identifier (TID) information (Info) field format in accordance with an embodiment of the invention.

FIG. 8 illustrates an AID TID Info field format of a Dynamic Control Per AID RID Info field in accordance with an embodiment of the invention.

FIG. 9 illustrates a High Efficiency (HE) control field format in a Dynamic Control Per AID TID Info field in accordance with an embodiment of the invention.

FIG. 10 is a process flow diagram of a method for wireless communications in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

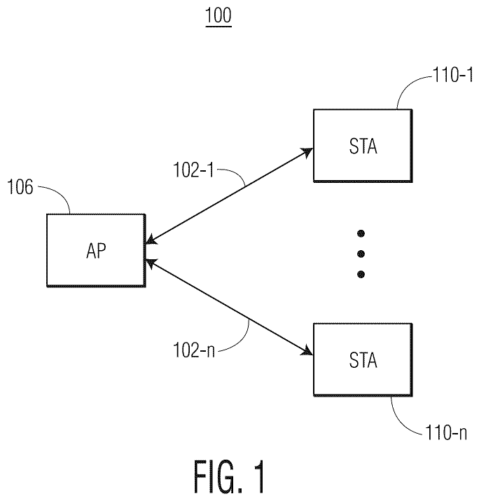

FIG. 1 depicts a wireless (e.g., WiFi) communications system 100 in accordance with an embodiment of the invention. In the embodiment depicted in FIG. 1, the wireless communications system 100 includes at least one AP 106 and at least one station (STA) 110-1, . . . , 110-n, where n is a positive integer. The wireless communications system can be used in various applications, such as industrial applications, medical applications, computer applications, and/or consumer or enterprise applications. In some embodiments, the wireless communications system is compatible with an IEEE 802.11 protocol. Although the depicted wireless communications system 100 is shown in FIG. 1 with certain components and described with certain functionality herein, other embodiments of the wireless communications system may include fewer or more components to implement the same, less, or more functionality. For example, in some embodiments, the wireless communications system includes multiple APs with multiple STAs, one AP with one STA, or one AP with multiple STAs. In another example, although the wireless communications system is shown in FIG. 1 as being connected in a certain topology, the network topology of the wireless communications system is not limited to the topology shown in FIG. 1. In some embodiments, the wireless communications system 100 described with reference to FIG. 1 involves single-link communications and the AP and the STA communicate through single communications link. In some embodiments, the AP 106 may be affiliated with an AP MLD, and a STA 100-j with j being an integer equal to one of 1 to n with n being an integer may be affiliated with a STA MLD j (=non-AP MLD j).

In the embodiment depicted in FIG. 1, the AP 106 may be implemented in hardware (e.g., circuits), software, firmware, or a combination thereof. The AP 106 may be fully or partially implemented as an integrated circuit (IC) device. In some embodiments, the AP 106 is a wireless AP compatible with at least one WLAN communications protocol (e.g., at least one IEEE 802.11 protocol). In some embodiments, the AP is a wireless AP that connects to a local area network (LAN) and/or to a backbone network (e.g., the Internet) through a wired connection and that wirelessly connects to one or more wireless stations (STAs), for example, through one or more WLAN communications protocols, such as the IEEE 802.11 protocol. In some embodiments, the AP includes at least one antenna, at least one transceiver operably connected to the at least one antenna, and at least one controller operably connected to the corresponding transceiver. In some embodiments, the transceiver includes a physical layer (PHY) device. The controller may be configured to control the transceiver to process received packets through the antenna. In some embodiments, the controller is implemented within a processor, such as a microcontroller, a host processor, a host, a digital signal processor (DSP), or a central processing unit (CPU), which can be integrated in a corresponding transceiver. In some embodiments, the AP 106 (e.g., a controller or a transceiver of the AP) implements upper layer Media Access Control (MAC) functionalities (e.g., beacon, association establishment, reordering of frames, etc.) and/or lower layer MAC functionalities (e.g., backoff, frame transmission, frame reception, etc.). Although the wireless communications system 100 is shown in FIG. 1 as including one AP, other embodiments of the wireless communications system 100 may include multiple APs. In these embodiments, each of the APs of the wireless communications system 100 may operate in a different frequency band. For example, one AP may operate in a 2.4 gigahertz (GHz) frequency band and another AP may operate in a 5 GHz frequency band.

In the embodiment depicted in FIG. 1, each of the at least one STA 110-1, . . . , 110-n may be implemented in hardware (e.g., circuits), software, firmware, or a combination thereof. The STA 110-1, . . . , or 110-n may be fully or partially implemented as IC devices. In some embodiments, the STA 110-1, . . . , or 110-n is a communication device compatible with at least one IEEE 802.11 protocol. In some embodiments, the STA 110-1, . . . , or 110-n is implemented in a laptop, a desktop personal computer (PC), a mobile phone, or other communications device that supports at least one WLAN communications protocol. In some embodiments, the STA 110-1, . . . , or 110-n implements a common MAC data service interface and a lower layer MAC data service interface. In some embodiments, the STA 110-1, . . . , or 110-n includes at least one antenna, at least one transceiver operably connected to the at least one antenna, and at least one controller connected to the corresponding transceiver. In some embodiments, the transceiver includes a PHY device. The controller may be configured to control the transceiver to process received packets through the antenna. In some embodiments, the controller is implemented within a processor, such as a microcontroller, a host processor, a host, a DSP, or a CPU, which can be integrated in a corresponding transceiver.

In the embodiment depicted in FIG. 1, the AP 106 communicates with the at least one STA 110-1, . . . , 110-n via a communication link 102-1, . . . , 102-n, where n is a positive integer. In some embodiments, data communicated between the AP and the at least one STA 110-1, . . . , 110-n includes MAC protocol data units (MPDUs). An MPDU may include a frame header, a frame body, and a trailer with the MPDU payload encapsulated in the frame body.

In some embodiments of a wireless communications system, a wireless device, e.g., an access point (AP) multi-link device (MLD) of a wireless local area network (WLAN) may transmit data to at least one associated station (STA) MLD. The AP MLD may be configured to operate with associated STA MLDs according to a communication protocol. For example, the communication protocol may be an Ultra High Reliability (UHR) communication protocol, or Institute of Electrical and Electronics Engineers (IEEE) 802.11bn communication protocol. In some embodiments of the wireless communications system described herein, different associated STAs within range of an AP operating according to the UHR communication protocol are configured to operate according to at least one other communication protocol, which defines operation in a Basic Service Set (BSS) with the AP, but are generally affiliated with lower reliable protocols. The lower reliable communication protocols (e.g., Extremely High Throughput (EHT) communication protocol that is compatible with IEEE 802.11be standards, High Efficiency (HE) communication protocol that is compatible with IEEE 802.11ax standards, Very High Throughput (VHT) communication protocol that is compatible with IEEE 802.11ac standards, etc.) may be collectively referred to herein as “legacy” communication protocols.

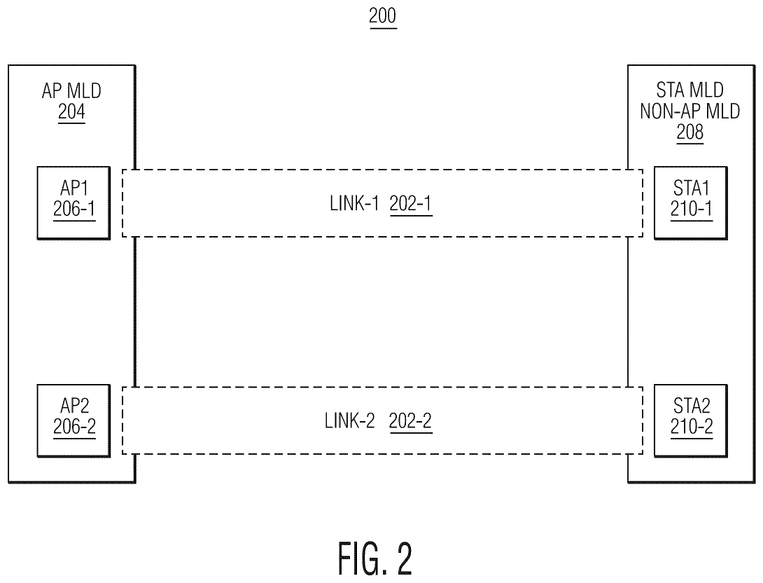

FIG. 2 depicts a multi-link (ML) communications system 200 that is used for wireless (e.g., WiFi) communications in accordance with an embodiment of the invention. In the embodiment depicted in FIG. 2, the multi-link communications system includes one AP multi-link device, which is implemented as AP MLD 204, and one non-AP STA multi-link device, which is implemented as STA MLD (non-AP MLD) 208. The multi-link communications system can be used in various applications, such as industrial applications, medical applications, computer applications, and/or consumer or enterprise applications. In some embodiments, the multi-link communications system may be a wireless communications system, such as a wireless communications system compatible with an IEEE 802.11 protocol. For example, the multi-link communications system may be a wireless communications system compatible with an IEEE 802.11bn protocol. Although the depicted multi-link communications system 200 is shown in FIG. 2 with certain components and described with certain functionality herein, other embodiments of the multi-link communications system may include fewer or more components to implement the same, less, or more functionality. For example, in some embodiments, the multi-link communications system includes a single AP MLD with multiple STA MLDs, or multiple AP MLDs with more than one STA MLD. In some embodiments, the legacy STAs (non-UHR STAs) may associate with one of the APs affiliated with the AP MLD. In another example, although the multi-link communications system is shown in FIG. 2 as being connected in a certain topology, the network topology of the multi-link communications system is not limited to the topology shown in FIG. 2.

In the embodiment depicted in FIG. 2, the AP MLD 204 includes two APs in two links, implemented as APs 206-1 and 206-2. In such an embodiment, the APs may be AP1 206-1 and AP2 206-2. In some embodiments, a common part of the AP MLD 204 implements upper layer Media Access Control (MAC) functionalities (e.g., beaconing, association establishment, reordering of frames, etc.) and a link specific part of the AP MLD 204, i.e., the APs 206-1 and 206-2, implement lower layer MAC functionalities (e.g., backoff, frame transmission, frame reception, etc.). The APs 206-1 and 206-2 may be implemented in hardware (e.g., circuits), software, firmware, or a combination thereof. The APs 206-1 and 206-2 may be fully or partially implemented as an integrated circuit (IC) device. In some embodiments, the APs 206-1 and 206-2 may be wireless APs compatible with at least one WLAN communications protocol (e.g., at least one IEEE 802.11 protocol). For example, the APs 206-1 and 206-2 may be wireless APs compatible with an IEEE 802.11bn protocol. In some embodiments, an AP MLD (e.g., AP MLD 204) connects to a local network (e.g., a LAN) and/or to a backbone network (e.g., the Internet) through a wired connection and wirelessly connects to wireless STAs, for example, through one or more WLAN communications protocols, such as an IEEE 802.11 protocol. In some embodiments, an AP (e.g., AP1 206-1 and/or AP2 106-2) includes at least one antenna, at least one transceiver operably connected to the at least one antenna, and at least one controller operably connected to the corresponding transceiver. In some embodiments, at least one transceiver includes a physical layer (PHY) device. The at least one controller may be configured to control the at least one transceiver to process received packets through the at least one antenna. In some embodiments, the at least one controller may be implemented within a processor, such as a microcontroller, a host processor, a host, a digital signal processor (DSP), or a central processing unit (CPU), which can be integrated in a corresponding transceiver. In some embodiments, each of the APs 206-1 or 206-2 of the AP MLD 204 may operate in a different BSS operating channel. For example, AP1 206-1 may operate in a 320 MHz (one million hertz) BSS operating channel at 6 Gigahertz (GHz) band and AP2 206-2 may operate in a 160 MHz BSS operating channel at 5 GHz band. Although the AP MLD 204 is shown in FIG. 2 as including two APs, other embodiments of the AP MLD 204 may include more than two APs or only one AP.

In the embodiment depicted in FIG. 2, the non-AP STA multi-link device, implemented as STA MLD 208, includes STAs non-AP STAs 210-1 and 210-2 on two links. In such an embodiment, the non-AP STAs may be STA1 210-1 and STA2 210-2. The STAs 210-1 and 210-2 may be implemented in hardware (e.g., circuits), software, firmware, or a combination thereof. The STAs 210-1 and 210-2 may be fully or partially implemented as an IC device. In some embodiments, the non-AP STAs 210-1 and 210-2 are part of the STA MLD 208, such that the STA MLD may be a communications device that wirelessly connects to a wireless AP MLD. For example, the STA MLD 208 may be implemented in a laptop, a desktop personal computer (PC), a mobile phone, or other communications device that supports at least one WLAN communications protocol. In some embodiments, the non-AP STA MLD 208 is a communications device compatible with at least one IEEE 802.11 protocol (e.g., an IEEE 802.11 bn protocol, an 802.11be protocol, an IEEE 802.11ax protocol, or an IEEE 802.11ac protocol). In some embodiments, the STA MLD 208 implements a common MAC data service interface and the non-AP STAs 210-1 and 210-2 implement a lower layer MAC data service interface.

In some embodiments, the AP MLD 204 and/or the STA MLD 208 may identify which communication links support multi-link operation during a multi-link operation setup phase and/or exchanges information regarding multi-link capabilities during the multi-link operation setup phase. In some embodiments, each of the non-AP STAs 210-1 and 210-2 of the STA MLD 208 may operate in a different frequency band. For example, the non-AP STA 210-1 may operate in the 2.4 GHz frequency band and the non-AP STA 210-2 may operate in the 5 GHz frequency band. In some embodiments, each STA includes at least one antenna, at least one transceiver operably connected to the at least one antenna, and at least one controller connected to the corresponding transceiver. In some embodiments, at least one transceiver includes a PHY device. The at least one controller may be configured to control the at least one transceiver to process received packets through the at least one antenna. In some embodiments, the at least one controller may be implemented within a processor, such as a microcontroller, a host processor, a host, a DSP, or a CPU, which can be integrated in a corresponding transceiver.

In the embodiment depicted in FIG. 2, the STA MLD 208 communicates with the AP MLD 204 via two communication links, e.g., link 1 202-1 and link 2 202-2. For example, each of the non-AP STAs 210-1 or 210-2 communicates with an AP 206-1 or 206-2 via corresponding communication links 202-1 or 202-2. In an embodiment, a communication link (e.g., link 1 202-1 or link 2 202-2) may include a BSS operating channel established by an AP (e.g., AP1 206-1 or AP2 206-2) that features multiple 20 MHz channels used to transmit frames (e.g., beacon frames, management frames, other than Beacon, Data frames, control frames etc. in Physical Layer Protocol Data Units (PPDUs)) between a first wireless device (e.g., an AP, an AP MLD, an STA, or an STA MLD) and a second wireless device (e.g., an AP, an AP MLD, an STA, or an STA MLD). In some embodiments, a 20 MHz channel covered by the BSS operating channel may be a punctured 20 MHz channel or an unpunctured 20 MHz channel. Although the STA MLD 208 is shown in FIG. 2 as including two non-AP STAs, other embodiments of the STA MLD 208 may include one non-AP STA or more than two non-AP STAs. In addition, although the AP MLD 204 communicates (e.g., wirelessly communicates) with the STA MLD 208 via the communications links 202-1 and 202-2, in other embodiments, the AP MLD 204 may communicate (e.g., wirelessly communicate) with the STA MLD 208 via more than two communication links or less than two communication links.

In some embodiments, a first MLD, e.g., an AP MLD or non-AP MLD (STA MLD), may transmit MLD-level management frames in a multi-link operation with a second MLD, e.g., STA MLD or AP MLD, to coordinate the multi-link operation between the first MLD and the second MLD. As an example, a management frame may be a channel switch announcement frame, a (Re) Association Request frame, a (Re) Association Response frame, a Disassociation frame, an Authentication frame, and/or a Block Acknowledgement (Ack) (BA) Action frame, etc. In some embodiments, an AP/STA of a first MLD may transmit link-level management frames to a STA/AP of a second MLD. In some embodiments, one or more link-level management frames may be transmitted via a cross-link transmission (e.g., according to an IEEE 802.11bn communication protocol). As an example, a cross-link management frame transmission may involve a management frame being transmitted and/or received on one link (e.g., link 1 202-1) while carrying information of another link (e.g., link 2 202-2). In some embodiments, a management frame is transmitted on any link (e.g., at least one of two links or at least one of multiple links) between a first MLD (e.g., AP MLD 204) and a second MLD (e.g., STA MLD 208). As an example, a management frame may be transmitted between a first MLD and a second MLD on any link (e.g., at least one of two links or at least one of multiple links) associated with the first MLD and the second MLD.

A wireless communications interference, such as In-device coexisting radio(s) (e.g., a Bluetooth transmitter), may interfere with a WLAN (e.g., Wi-Fi) transmitter because the WLAN (e.g., Wi-Fi) transmitter might not know for periodic activity or might not know for aperiodic activity beforehand when the interference may occur. A WLAN (e.g., Wi-Fi) device can announce that the device has one or more coexisting radios/transmitters when performing the association or after the in-device coexisting radio(s) is turned on or turned off. In some embodiments, the activity of coexisting radios/transmitters are link-level information. This information can help its connected WLAN (e.g., Wi-Fi) device to optimize rate adaptation in transmission. Knowing that a WLAN (e.g., Wi-Fi) receiver's error packets are resulted from a coexisting interference instead of a bad channel condition can improve wireless transmission throughput, for example, by preventing a WLAN (e.g., Wi-Fi) transmitter from dropping data packets, resulting in a lower data rate. When an AP executes frame exchanges with multiple STAs in low capability mode in a TXOP, the AP may only use the number of spatial streams (Nss), bandwidth that are smaller than the STA's operating parameters (operating Nss, operating bandwidth). In such case, the initiating Trigger frame that solicits the switch from low capability mode to high capability mode can carry the Nss, bandwidth selected by the AP to each STA. With such information, the STA can activate the announced Nss, bandwidth specific to it, instead of activating its operating Nss and bandwidth to save power.

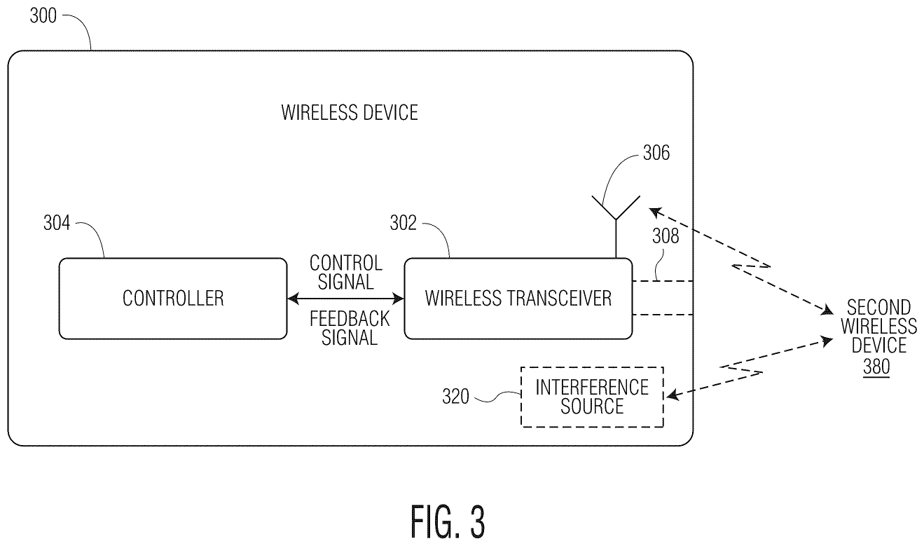

FIG. 3 depicts a wireless device 300 in accordance with an embodiment of the invention. The wireless device 300 can be used in the wireless communications system 100 depicted in FIG. 1 and/or the multi-link communications system 200 depicted in FIG. 2 for each link independently. For example, the wireless device 300 may be an embodiment of the AP 106 depicted in FIG. 1, the STA 110-1, . . . , 110-n depicted in FIG. 1, the APs 206-1, 206-2 depicted in FIG. 2, and/or the STAs 210-1, 210-2 depicted in FIG. 2. In the embodiment depicted in FIG. 3, the wireless device 300 includes a wireless transceiver 302, a controller 304 operably connected to the wireless transceiver, and at least one antenna 306 operably connected to the wireless transceiver. In some embodiments, the wireless device 300 may include at least one optional network port 308 operably connected to the wireless transceiver. In some embodiments, the wireless transceiver includes a physical layer (PHY) device. The wireless transceiver may be any suitable type of wireless transceiver. For example, the wireless transceiver may be a LAN transceiver (e.g., a transceiver compatible with an IEEE 802.11 protocol). In some embodiments, the wireless device 300 includes multiple transceivers. The controller may be configured to control the wireless transceiver (e.g., by generating a control signal) to process packets received through the antenna and/or the network port and/or to generate outgoing packets to be transmitted through the antenna and/or the network port. In some embodiments, the wireless transceiver transmits one or more feedback signals to the controller. In some embodiments, the controller is implemented within a processor, such as a microcontroller, a host processor, a host, a DSP, or a CPU. In some embodiments, the wireless transceiver 302 is implemented in hardware (e.g., circuits), software, firmware, or a combination thereof. The antenna may be any suitable type of antenna. For example, the antenna may be an induction type antenna such as a loop antenna or any other suitable type of induction type antenna. However, the antenna is not limited to an induction type antenna. The network port may be any suitable type of port.

In some embodiments, an interference source 320 is located within the wireless device. For example, the interference source 320 may be an in-device coexisting transmitter/radio (e.g., a Bluetooth transmitter/radio) and/or other known interference source. In some embodiments, the wireless device 300 may further include a second wireless transceiver, and the interference source includes the second wireless transceiver. In some embodiments, the wireless transceiver 302 is compatible with an Institute of Electrical and Electronics Engineers (IEEE) 802.11 protocol, while the second wireless transceiver is not compatible with the IEEE 802.11 protocol. For example, the second wireless transceiver may be compatible with a short range wireless communications protocol (e.g., a Bluetooth communications protocol).

In accordance with an embodiment of the invention, the controller 304 is configured to determine an arrangement of control information, and the wireless transceiver 302 is configured to announce the arrangement of the control information in a first frame exchange with a second wireless device 380 in a transmit opportunity (TXOP) and to conduct subsequent frame exchanges with the second wireless device 380 based on the arrangement of the control information, for example, through the at least one antenna 306. In some embodiments, the control information contains dynamic control information that may evolve or change over time. In some embodiments, the arrangement of the dynamic control information includes at least one of in-device interference information of the TXOP holder (e.g. unavailable time), power saving information, dynamic sub-band switch information, and per TXOP responder's transmitter/receiver (Tx/Rx) parameter negotiation information for the TXOP. In some embodiment, per TXOP responder's transmitter/receiver (Tx/Rx) parameters for different TXOP responders are different. In some embodiments, the controller 304 is further configured to generate an initiating control frame (ICF) that includes the arrangement of the control information. In some embodiments, one of or both of two types of the follow dynamic control information can be carried in an initiating control frame: the dynamic control information for all addressed TXOP responders, e.g., the TXOP holder's available time information and unavailable information, one or multiple initial control information for one or multiple addressed TXOP responders, e.g., a Buffer Status Report Poll (BSRP) Trigger frame in a TXOP carries the different the Tx/Rx parameters (Nss, bandwidth (BW)) for two TXOP responders being used in the TXOP. In some embodiments, the arrangement of the dynamic control information includes a dynamic control information triple, and the dynamic control information triple includes type information, length information, and content information. In some embodiments, the arrangement of the dynamic control information includes a dynamic control information pair, and the dynamic control information pair includes type information and content information. In some embodiments, the dynamic control information is carried in a special User Info field of a Trigger frame with the specific value in AID12 field of the special User Info field to indicate the dynamic control information type. In some embodiments, the dynamic control information is carried in a special Per AID TID Info field of a Multi-STA BA frame with the specific value in AID11 subfield of the special Per AID TID Info field to indicate the dynamic control information type. In some embodiments, the wireless transceiver 302 is further configured to receive a second arrangement of the dynamic control information from the second wireless device in the first frame exchange with the second wireless device 380 in the TXOP, and to conduct the subsequent frame exchanges in the TXOP with the second wireless device 380 based on the arrangement of the dynamic control information and the second arrangement of the dynamic control information. In some embodiments, the dynamic control information of the second arrangement is carried in the responding frame (ICR) solicited by the ICF or the other responding control frame, e.g., dynamic control information (e.g., TXOP responder's unavailable information, the reason of missed frames in the solicited A-MPDU etc.) in a Multi-STA BA solicited by the A-MPDU is carried in the ICR solicited by the ICF or the other responding control frame. In some embodiments, the controller 304 is further configured to generate an initiating control frame that contains the arrangement of the control information, and the wireless transceiver 302 is further configured to receive, from the second wireless device 380, a responding control frame that contains the second arrangement of the control information. In some embodiments, the initiating control frame includes a Buffer Status Report Poll (BSRP) trigger frame, and the responding control frame includes a multi-station (multi-STA) block acknowledgement (BA) frame. In some embodiments, the BSRP trigger frame contains information that indicates whether the Multi-STA BA frame is contained in a non-High Throughput (HT) Physical Layer Protocol Data Unit (PPDU) when the BSRP trigger frame solicits the Multi-STA BA frame from a single recipient. In some embodiments, the Multi-STA BA frame does not carry a BA bitmap for acknowledging an Aggregate MAC Protocol Data Unit (A-MPDU). In some embodiments, the Multi-STA BA frame includes a Per Association ID (AID) Traffic Identifier (TID) information (Info) field with the dynamic control information (e.g. unavailable time) for all addressed or associated stations (STAs). In some embodiments, the Multi-STA BA frame includes multiple Dynamic Control Per Association ID (AID) Traffic Identifier (TID) information (Info) (Dynamic Control Per AID TID) fields with the dynamic control information (e.g. reason not receiving the various frames of soliciting A-MPDU correctly) in one of the for multiple Dynamic Control Per AID TID fields being for one of all addressed or associated stations (STAs). In some embodiments, the initiating control frame includes a block acknowledgement response (BAR) frame, and the responding control frame includes a block acknowledgement (BA) frame. In some embodiments, the initiating control frame includes a multi-user-request to send (MU-RTS) frame, the responding control frame includes a clear to send (CTS) frame, and a TXOP holder of the TXOP does not send feedback information. In some embodiments, the MU-RTS frame contains information that indicates whether the responding CTS frame is contained in a non-High Throughput (HT) Physical Layer Protocol Data Unit (PPDU) when the MU-RTS frame solicits the CTS frame from a single recipient. In some embodiments, the initiating control frame includes a Buffer Status Report Poll (BSRP) trigger frame, the responding control frame includes a quality of service (QOS) null frame, a TXOP holder of the TXOP does not send feedback information. In some embodiments, the BSRP trigger frame contains information that indicates whether the QoS Null frame is contained in a non-High Throughput (HT) Physical Layer Protocol Data Unit (PPDU) when the BSRP trigger frame solicits the QoS Null frame from a single recipient. In some embodiments, the wireless transceiver 302 is further configured to transmit the initiating control frame to the second wireless device 380. In some embodiments, the initiating control frame includes a special User information (Info) field (e.g., a Dynamic Control User Info field) for dynamic control information (e.g. TXOP holder's unavailable information) for all addressed or associated stations (STAs), i.e., TXOP responders. In some embodiments, the initiating control frame includes one or multiple Dynamic Control User information (Info) fields for dynamic control information with each (e.g., for dynamic control information (Tx/Rx parameters restriction)) of the Dynamic Control User Info fields addressed to one of the addressed STAs. In some embodiments, the Dynamic Control User information (Info) field for specific user and the Dynamic Control User Info field in the initiating control frame (ICF frame) have the different values in their AID12 fields. In some embodiment, the Dynamic Control User Info field for an addressed STA immediately follows the User Info field for the addressed STA. In some embodiments, the responding frame solicited by the initiating control frame includes a Dynamic Control Per AID TID field for dynamic control information (e.g., TXOP responder's unavailable information). In some embodiments, the responding control frame solicited by the A-MPDU in a trigger based (TB) PPDU or non-TB PPDU includes multiple Dynamic Control Per AID TID fields for dynamic control information of multiple addressed STAs with each Dynamic Control Per AID TID field carrying the dynamic control information (e.g., the reason of not receiving frames in the A-MPDU correctly) being for one addressed STA. In some embodiments, the Dynamic Control Per AID TID Info field for specific user and the Dynamic Control Per AID TID Info field in the responding control frame (ICR frame) have the different values in their AID11 fields. In some embodiments, the wireless device 300 or the second wireless device 380 includes a wireless access point (AP) or a wireless non-AP station (STA). In some embodiments, the wireless device 300 is compatible with an Institute of Electrical and Electronics Engineers (IEEE) 802.11 protocol. In some embodiments, the wireless device includes a wireless multi-link device (MLD), the second wireless device 380 includes a second wireless MLD, and the wireless transceiver 302 is further configured to conduct frame exchanges with the second wireless MLD through a wireless link between the wireless MLD and the second wireless MLD.

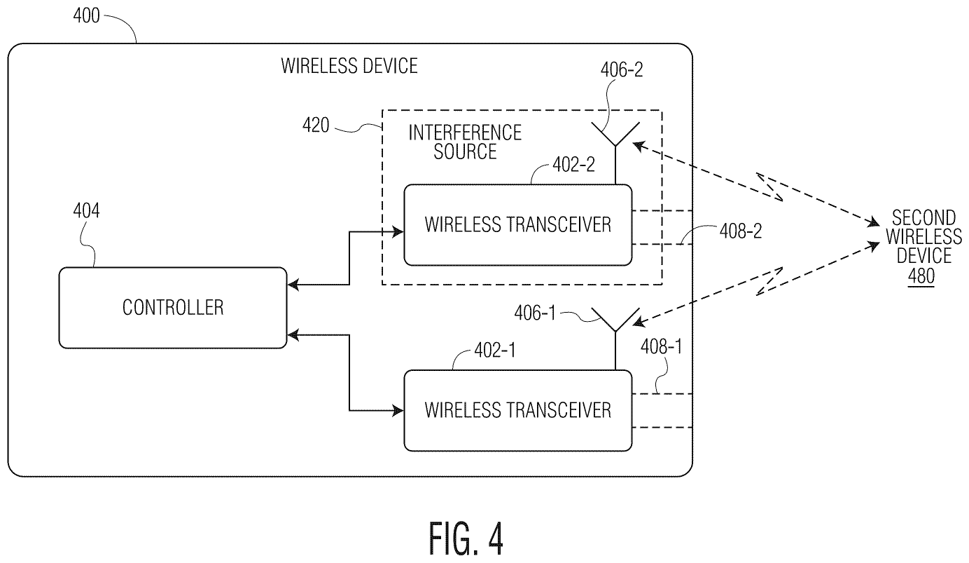

FIG. 4 depicts a wireless device 400 with multiple wireless transceivers 402-1, 402-2 in accordance with an embodiment of the invention. The wireless device 400 depicted in FIG. 4 may be an embodiment of the wireless device 300 depicted in FIG. 3. However, the wireless device 300 depicted in FIG. 3 is not limited to the embodiment depicted in FIG. 4. The wireless device 400 can be used in the wireless communications system 100 depicted in FIG. 1 and/or the multi-link communications system 200 depicted in FIG. 2. For example, the wireless device 400 may be an embodiment of the AP 106 depicted in FIG. 1, the STA 110-1, . . . , 110-n depicted in FIG. 1, the APs 206-1, 206-2 depicted in FIG. 2, and/or the STAs 210-1, 210-2 depicted in FIG. 2. In the embodiment depicted in FIG. 4, the wireless device 400 includes the first wireless transceiver 402-1, the second wireless transceiver 402-2, a controller 404 operably connected to the wireless transceiver, a first antenna 406-1 operably connected to the first wireless transceiver 402-1, and a second antenna 406-2 operably connected to the second wireless transceiver 402-2. In some embodiments, the wireless device 400 may include one or more optional network ports 408-1, 408-2 operably connected to the wireless transceivers 402-1, 402-2. In some embodiments, at least one of the wireless transceivers 402-1, 402-2 includes a physical layer (PHY) device. The wireless transceivers 402-1, 402-2 may be any suitable type of wireless transceiver. For example, one of the wireless transceivers 402-1, 402-2 may be a WLAN transceiver (e.g., a transceiver compatible with an IEEE 802.11 protocol) while another one of the wireless transceivers 402-1, 402-2 may be a short-range transceiver (e.g., a transceiver compatible with a Bluetooth communications protocol). The controller may be configured to control the wireless transceivers 402-1, 402-2 (e.g., by generating one or more control signals) to process packets received through the antennas 406-1, 406-2 and/or the network ports 408-1, 408-2 and/or to generate outgoing packets to be transmitted through the antennas 406-1, 406-2 and/or the network ports 408-1, 408-2. In some embodiments, the wireless transceivers 402-1, 402-2 transmits one or more feedback signals to the controller 404. In some embodiments, the controller is implemented within a processor, such as a microcontroller, a host processor, a host, a DSP, or a CPU. In some embodiments, at least one of the wireless transceivers 402-1, 402-2 is implemented in hardware (e.g., circuits), software, firmware, or a combination thereof. The antenna may be any suitable type of antenna. For example, at least one of the antennas 406-1, 406-2 may be an induction type antenna such as a loop antenna or any other suitable type of induction type antenna. However, the antennas 406-1, 406-2 are not limited to induction type antennas. The network ports 408-1, 408-2 may be any suitable type of ports. For example, at least one of the network ports 408-1, 408-2 is an LAN port (e.g., an Ethernet port). Although the depicted wireless device 400 is shown in FIG. 4 with certain components and described with certain functionality herein, other embodiments of the wireless device 400 may include fewer or more components to implement the same, less, or more functionality. For example, although the wireless device 400 is shown in FIG. 4 as being connected in a certain topology, the network topology of the wireless device 400 is not limited to the topology shown in FIG. 4. In another example, in some embodiments, the wireless device includes multiple controllers with multiple wireless transceivers, a single antenna, more than two wireless transceivers, more than one antennas, and/or more than two network ports.

In some embodiments, an interference source 420 is located within the wireless device 400 (e.g., a link of wireless device in the wireless device is a MLD with more than one link). For example, the interference source 420 may be an in-device coexisting transceiver/radio (e.g., a Bluetooth transceiver/radio) and/or other known interference source. In some embodiments, the wireless device further includes the second wireless transceiver 402-2, and the interference source 420 includes the second wireless transceiver 402-2 and/or the second antenna 406-2. In some embodiments, the first wireless transceiver 402-1 is compatible with an Institute of Electrical and Electronics Engineers (IEEE) 802.11 protocol, and the second wireless transceiver 402-2 is not compatible with the IEEE 802.11 protocol. In some embodiments, the second wireless transceiver 402-2 is compatible with a short range wireless communications protocol (e.g., a Bluetooth communications protocol). In some embodiments, the controller 404 is configured to generate a frame (e.g., a PPDU carrying a beacon frame, a management frame other than Beacon, Data frame(s), or control frame etc.) that includes interference information indicating an existence or an occurrence of a wireless communications interference and the wireless transceiver 402-1 is configured to transmit the frame through the antenna 406-1. In some embodiments, the wireless device 400 is a wireless access point (AP) or a non-AP wireless station (STA) device. In some embodiments, the wireless device 400 is a component of a multi-link device (MLD)'s link.

In accordance with an embodiment of the invention, the controller 404 is configured to determine an arrangement of control information, and the wireless transceiver 402-1 is configured to announce the arrangement of the dynamic control information in a first frame exchange with a second wireless device 480 in a transmit opportunity (TXOP) and to conduct subsequent frame exchanges with the second wireless device 480 based on the arrangement of the dynamic control information, for example, through the at least one antenna 406-1. In some embodiments, the arrangement of the dynamic control information includes at least one of in-device interference information of the TXOP holder (e.g. unavailable time), power saving information, dynamic sub-band switch information, and per TXOP responder's transmitter/receiver (Tx/Rx) parameter negotiation information for the TXOP. In some embodiment, per TXOP responder's transmitter/receiver (Tx/Rx) parameters for different TXOP responders are different. In some embodiments, the controller 404 is further configured to generate an initiating control frame (ICF) that includes the arrangement of the control information. In some embodiments, one of or both of two types of the follow dynamic control information can be carried in an initiating control frame: the dynamic control information for all addressed TXOP responders, e.g., the TXOP holder's available time information and unavailable information, one or multiple initial control information for one or multiple addressed TXOP responders, e.g., a BSRP Trigger frame in a TXOP carries the different the Tx/Rx parameters (Nss, BW) for two TXOP responders being used in the TXOP. In some embodiments, the arrangement of the dynamic control information includes a dynamic control information triple, and the dynamic control information triple includes type information, length information, and content information. In some embodiments, the arrangement of the dynamic control information includes a dynamic control information pair, and the dynamic control information pair includes type information and content information. In some embodiments, the dynamic control information is carried in a special User Info field of a Trigger frame with the specific value in AID12 field of the special User Info field to indicate the dynamic control information type. In some embodiments, the dynamic control information is carried in a special Per AID TID Info field of a Multi-STA BA frame with the specific value in AID11 subfield of the special Per AID TID Info field to indicate the dynamic control information type. In some embodiments, the wireless transceiver 402-1 is further configured to receive a second arrangement of the dynamic control information from the second wireless device in the first frame exchange with the second wireless device 480 in the TXOP, and to conduct the subsequent frame exchanges in the TXOP with the second wireless device 480 based on the arrangement of the dynamic control information and the second arrangement of the dynamic control information. In some embodiments, the dynamic control information of the second arrangement is carried in the responding frame (ICR) solicited by the ICF or the other responding control frame, e.g., dynamic control information (e.g., TXOP responder's unavailable information, the reason of missed frames in the solicited A-MPDU etc.) in a Multi-STA BA solicited by the A-MPDU is carried in the ICR solicited by the ICF or the other responding control frame. In some embodiments, the controller 404 is further configured to generate an initiating control frame that contains the arrangement of the control information, and the wireless transceiver 302 is further configured to receive, from the second wireless device 380, a responding control frame that contains the second arrangement of the control information. In some embodiments, the initiating control frame includes a Buffer Status Report Poll (BSRP) trigger frame, and the responding control frame includes a multi-station (multi-STA) block acknowledgement (BA) frame. In some embodiments, the BSRP trigger frame contains information that indicates whether the Multi-STA BA frame is contained in a non-High Throughput (HT) Physical Layer Protocol Data Unit (PPDU) when the BSRP trigger frame solicits the Multi-STA BA frame from a single recipient. In some embodiments, the Multi-STA BA frame does not carry a BA bitmap for acknowledging an Aggregate MAC Protocol Data Unit (A-MPDU). In some embodiments, the Multi-STA BA frame includes a Per Association ID (AID) Traffic Identifier (TID) information (Info) field with the dynamic control information (e.g. unavailable time) for all addressed or associated stations (STAs). In some embodiments, the Multi-STA BA frame includes multiple Dynamic Control Per Association ID (AID) Traffic Identifier (TID) information (Info) (Dynamic Control Per AID TID) fields with the dynamic control information (e.g. reason not receiving the various frames of soliciting A-MPDU correctly) in one of the for multiple Dynamic Control Per AID TID fields being for one of all addressed or associated stations (STAs). In some embodiments, the initiating control frame includes a block acknowledgement response (BAR) frame, and the responding control frame includes a block acknowledgement (BA) frame. In some embodiments, the initiating control frame includes a multi-user-request to send (MU-RTS) frame, the responding control frame includes a clear to send (CTS) frame, and a TXOP holder of the TXOP does not send feedback information. In some embodiments, the MU-RTS frame contains information that indicates whether the responding CTS frame is contained in a non-High Throughput (HT) Physical Layer Protocol Data Unit (PPDU) when the MU-RTS frame solicits the CTS frame from a single recipient. In some embodiments, the initiating control frame includes a Buffer Status Report Poll (BSRP) trigger frame, the responding control frame includes a quality of service (QOS) null frame, a TXOP holder of the TXOP does not send feedback information. In some embodiments, the BSRP trigger frame contains information that indicates whether the QoS Null frame is contained in a non-High Throughput (HT) Physical Layer Protocol Data Unit (PPDU) when the BSRP trigger frame solicits the QoS Null frame from a single recipient. In some embodiments, the wireless transceiver 402-1 is further configured to transmit the initiating control frame to the second wireless device 480. In some embodiments, the initiating control frame includes a special User information (Info) field (e.g., a Dynamic Control User Info field) for dynamic control information (e.g. TXOP holder's unavailable information) for all addressed or associated stations (STAs), i.e., TXOP responders. In some embodiments, the initiating control frame includes one or multiple Dynamic Control User information (Info) fields for dynamic control information with each (e.g., for dynamic control information (Tx/Rx parameters restriction)) of the Dynamic Control User Info fields addressed to one of the addressed STAs. In some embodiment, the Dynamic Control User Info field for an addressed STA immediately follows the User Info field for the addressed STA. In some embodiments, the responding frame solicited by the initiating control frame includes a Dynamic Control Per AID TID field for dynamic control information (e.g., TXOP responder's unavailable information). In some embodiments, the responding frame solicited by the A-MPDU in a TB PPDU includes multiple Dynamic Control Per AID TID fields for dynamic control information of multiple addressed STAs with each Dynamic Control Per AID TID field carrying the dynamic control information (e.g., the reason of not receiving frames in the A-MPDU correctly) being for one addressed STA. In some embodiments, the wireless device 400 or the second wireless device 480 includes a wireless access point (AP) or a wireless non-AP station (STA). In some embodiments, the wireless device 400 is compatible with an Institute of Electrical and Electronics Engineers (IEEE) 802.11 protocol. In some embodiments, the wireless device includes a wireless multi-link device (MLD), the second wireless device 480 includes a second wireless MLD, and the wireless transceiver 402-1 is further configured to conduct frame exchanges with the second wireless MLD through a wireless link between the wireless MLD and the second wireless MLD.

Some examples of dynamic control information (feedback information or the other control information) for various purposes are described as follows. In a TXOP, the TXOP holder can notify one or multiple of the bandwidth (BW), Modulation Coding Scheme (MCS), number of spatial streams (Nss) tuples for one or multiple addressed STAs (TXOP responders) that will be used by one or multiple TXOP responders within the TXOP for the enhanced power save (low-capacity mode listening to high-capacity mode for frame exchange). In a TXOP, the TXOP responder can notify the available BW, available time, unavailable time (feedback) because of the in-device non-WiFi radio activity (for in-device radio coexistence). A STA/AP as the TXOP holder or the TXOP responder may announce its available time, unavailable time because of the in-device non-WiFi radio activity without soliciting. A STA and AP may negotiate the transmitter/receiver (Tx/Rx) parameters for the TXOP or a service period (SP). The recipient of an A-MPDU may notify the reason why the frames in A-MPDU are not received correctly such that the A-MPDU transmitter will not drop the Tx MCS wrongly. The Enhanced Multi-Link-Single-Radio (EMLSR) mode needs to be supported under in-device radio coexistence (e.g., in-device interference information). The TXOP protection, dynamic BW negotiation needs to be supported under enhanced power save, in-device radio coexistence. The MU operation needs to be supported under enhanced power save (low capability mode), in-device radio coexistence. One exception to this may be the Tx/Rx parameters negotiation. The ICF and ICR being selected need to support such combined MAC features. A STA/AP can announce whether it supports the enhanced power save feature (low capability mode), in-device coexistence feature, DSO (dynamic sub-band switch), and Tx/Rx parameter negotiation separately.

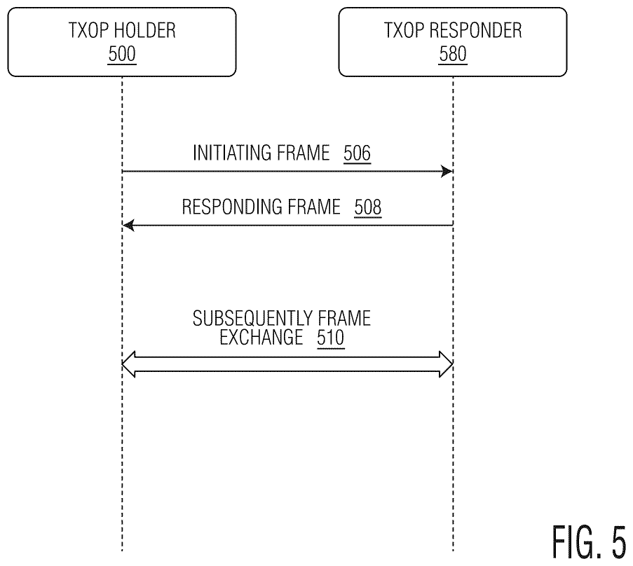

FIG. 5 shows a swim-lane diagram illustrating an example of frame exchanges between a TXOP holder 500 and a TXOP responder 580 (or multiple TXOP responders (not shown in FIG. 5). Although operations in the example procedure in FIG. 5 are described in a particular order, in some embodiments, the order of the operations in the example procedure may be altered so that certain operations may be performed in an inverse order or so that certain operations may be performed, at least in part, concurrently with other operations. The TXOP holder 500 starts or boots up. In operation 506, the TXOP holder 500 sends an initiating frame containing a first arrangement with or without dynamic control information to the TXOP responder(s) 580 in a first frame exchange between the TXOP holder 500 and the TXOP responder(s) 580 in a TXOP. In operation 508, the TXOP responder(s) 580 sends back the responding frame(s) containing a second arrangement with or without dynamic control information to the TXOP holder 500 in the first frame exchange between the TXOP holder 500 and the TXOP responder 580 (s) in the TXOP. In operation 510, subsequent frame exchanges are conducted between the TXOP holder 500 and the TXOP responder 580, for example, in the TXOP, based on the first and second arrangements of the control information. In some embodiments, each of the first and second arrangements of the dynamic control information includes at least one of in-device interference information, power saving information, the Tx/Rx parameters (e.g., BW, Nss, MCS) being used by the TXOP responders after switching from low capability mode to high capability mode, dynamic sub-band switch information, and transmitter/receiver (Tx/Rx) parameter negotiation information.

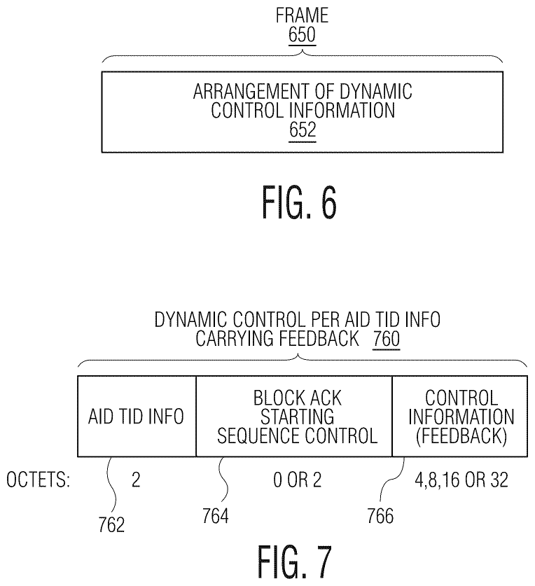

FIG. 6 illustrates a frame format 650 in accordance with an embodiment of the invention. The frame format 650 illustrated in FIG. 6 can be used for communications by the wireless communications system 100 depicted in FIG. 1, the multi-link (ML) communications system 200 depicted in FIG. 2, the wireless device 300 depicted in FIG. 3, the wireless device 400 depicted in FIG. 4, and/or the TXOP holder 500 and the TXOP responder(s) 580 depicted in FIG. 5. The frame format 650 illustrated in FIG. 6 may be an embodiment of an initiating frame from the TXOP holder 500 to the TXOP responder(s) 580 in a first frame exchange between the TXOP holder 500 and the TXOP responder(s) 580 in a TXOP and/or a responding frame from the TXOP responder 580 to the TXOP holder 500 in the first (or the other) frame exchange between the TXOP holder 500 and the TXOP responder 580 in the TXOP. In the embodiment depicted in FIG. 6, the frame format 650 includes an arrangement of dynamic control information 652, which may be located in a header and/or a frame body of the frame format 650. In some embodiments, the arrangement of the dynamic control information includes at least one of in-device interference information, power saving information, the Tx/Rx parameters (e.g., BW, Nss, MCS) being used by the TXOP responders after switching from low capability mode to high capability mode, dynamic sub-band switch information, and transmitter/receiver (Tx/Rx) parameter negotiation information. In some embodiments, the frame format 650 contains one or more fields to carry the dynamic control information 652. In some embodiments, the multiple fields to carry the dynamic control information 652 have one field for multiple addressed STAs, and/or each of the multiple fields for one addressed STA.

Some implementations of dynamic control information organization, for example, by the wireless communications system 100 depicted in FIG. 1, the multi-link (ML) communications system 200 depicted in FIG. 2, the wireless device 300 depicted in FIG. 3, the wireless device 400 depicted in FIG. 4, and/or the TXOP holder 500 and the TXOP responder 580 (s) depicted in FIG. 5 are described as follows.

In some embodiments, a dynamic control information triple for carrying dynamic control information is organized as <Type, Length, Content>. In some embodiments, Type indicates one of following, but not limited to, Unavailable time information, TXOP Holder's Notification of Tx/Rx parameters used by the TXOP responder, Tx/Rx parameter negotiation. In some embodiments, Length indicates the Content length of the indicated control type. In some embodiments, Content carries the information of the indicated control type.

In some embodiments, a dynamic control information pair for carrying dynamic control information is organized as <Type, Content>. In some embodiments, each dynamic control information is carried in one Dynamic Control Per AID TID Info field of a Multi-STA Block Acknowledgement (BA) frame. In some embodiments, two types of control information cannot be carried in one Dynamic Control Per AID TID Info field. In some embodiments, each control information is carried in one or multiple Dynamic Control User Info fields (if one Dynamic Control User Info field cannot carry the information) of a trigger frame (at least BSRP Trigger frame or MU-RTS frame). In some embodiments, two types of control information cannot be carried in one Dynamic Control User Info field. In some embodiments, the Type, Content are carried in Block Ack Bitmap subfield (e.g., being repurposed to carry the dynamic control information). In some embodiments, the Type of a Type, Content pair is carried in TID subfield (being repurposed to carry the dynamic control information, and the Content of a Type, Content pair is carried in Block Ack Bitmap subfield (being repurposed to carry the dynamic control information. In some embodiments, in a Multi-STA BA frame, the Dynamic Control Per AID TID Info field carrying the dynamic control information for a specific STA is located immediately after the Per AID TID field carrying the BA information (if exists) addressed to the STA. In some embodiments, in a Trigger frame, the Dynamic Control User Info field has the same length as the Special User Info field in the same Trigger type of the Trigger frame being EHT variant Trigger frame. In some embodiments, the Trigger Dependent User Info field of a Dynamic Control User Info field if exists in the Dynamic Control User Info field is reserved. In some embodiments, the Type, Content are carried in B12 to B39 of the Dynamic Control User Info field. In some embodiments, in a Trigger frame, the Dynamic Control User Info field carrying the dynamic control information for a specific STA is located immediately after the User Info field addressed to the STA.

In some embodiments, each dynamic control information (Content) is carried in one Dynamic Control Per AID TID Info field of a Multi-STA Block Acknowledgement (BA) frame where the AID12 field of Dynamic Control Per AID TID Info field has specific value to indicate the type of the dynamic control information. In some embodiments, each dynamic control information is carried in one Dynamic Control User Info field of a Trigger frame where the AID12 field of Dynamic Control User Info field has specific value to indicate the type of the dynamic control information. In some embodiments, the Content is carried in a Block Ack Bitmap subfield (e.g., being repurposed to carry the dynamic control information. In some embodiments, in a Multi-STA BA frame, the Dynamic Control Per AID TID Info field carrying the dynamic control information for a specific STA is located immediately after the Per AID TID field carrying the BA information (if exists) addressed to the STA. In some embodiments, in a Trigger frame, the Dynamic Control User Info field has the same length as the Special User Info field in the same Trigger type of the Trigger frame being EHT variant Trigger frame. In some embodiments, the Trigger Dependent User Info field of a Dynamic Control User Info field if exists in the Dynamic Control User Info field is reserved. In some embodiments, the Content is carried in B12 to B39 of the Dynamic Control User Info field. In some embodiments, in a Trigger frame, the Dynamic Control User Info field carrying the dynamic control information for a specific STA is located immediately after the User Info field addressed to the STA.

In some embodiments, an initiating/responding Control frame (ICF/ICR) carries 0, one or more of control information, control information triples/pairs.

Some implementations of dynamic control information in Frame with per recipient field, for example, by the wireless communications system 100 depicted in FIG. 1, the multi-link (ML) communications system 200 depicted in FIG. 2, the wireless device 300 depicted in FIG. 3, the wireless device 400 depicted in FIG. 4, and/or the TXOP holder 500 and the TXOP responder(s) 580 depicted in FIG. 5 are described as follows.

In some embodiments, an initiating/responding control frame with Per recipient field (e.g., a User Info field in a BSRP/MU-RTS Trigger frame or a new defined Trigger frame, a Per AID TID Info field in a Multi-STA BA frame) carries one or more dynamic control information, dynamic control information pairs in one or more Per recipient field (a Dynamic Control Special User Info field in a BSRP/MU-RTS Trigger or the other new defined frame, a Dynamic Control Per AID TID Info field in a Multi-STA BA frame or the other new defined frame).

In some embodiments, two types of Dynamic Control Special User Info fields are defined for a BSRP/MU-RTS Trigger or other Trigger frame. In some embodiments, the Dynamic Control Special User Info field for multiple addressed/associated STAs and the Dynamic Control Special User Info field for one specific addressed STA have different special values (e.g., values more than 2007) in their AID12 fields to identify the types of Dynamic Control Special User Info fields. In some embodiments, in one variant, the control information triple(s) for all addressed/associated STAs are carried in Padding part right after 16-bit all 1s.

In some embodiments, the Dynamic Control Special User Info field for an addressed STA follows the User Info field for the STA. In some embodiments, in one variant, the Dynamic Control Special User Info field for an addressed STA has the same value in its AID12 field as the AID12 field in the User Info field for the STA. In some embodiments, in another variant, each Dynamic Control Special User Info field for an addressed STA has the same special value (a value more than 2007) in its AID12 field. In some embodiments, in another variant, each Dynamic Control Special User Info field of one type of dynamic control information for an addressed STA has the same special value (a value more than 2007) in its AID12 field to indicate the dynamic control information type.

In some embodiments, the official name of soliciting control frame (e.g., a BSRP Trigger frame or a MU-RTS frame) is ICF (initial control frame), and the official name of responding control frame (e.g., a Multi-STA BA frame) is called ICR (initial control responding frame).

In some embodiments, two types of Dynamic Control Per AID TID Info fields are defined for a Multi-STA BA frame. In some embodiments, the Dynamic Control Per AID TID Info field for multiple addressed/associated STAs and the Dynamic Control Per AID TID Info field for one addressed STA have different special values in their AID11 fields to identify the types of Control Per AID TID Info fields. In some embodiments, the Dynamic Control Per AID TID field for an addressed STA follows the Per AID TID field (if exists) for the STA. In some embodiments, in one variant, the Dynamic Control Per AID TID field for an addressed STA has the same value in its AID11 subfield as the AID11 field in the Per AID TID field for the STA. In some embodiments, in one variant, each Dynamic Control Per AID TID field for an addressed STA has the same special value (e.g., a value more than 2007). In some embodiments, in one variant, each Dynamic Control Per AID TID field of one type of dynamic control information for an addressed STA has the same special value (e.g., a value more than 2007) in its AID11 subfield to indicate the dynamic control information type.

Some implementations of control Information in Frame without per recipient field, for example, by the wireless communications system 100 depicted in FIG. 1, the multi-link (ML) communications system 200 depicted in FIG. 2, the wireless device 300 depicted in FIG. 3, the wireless device 400 depicted in FIG. 4, and/or the TXOP holder 500 and the TXOP responder(s) 580 depicted in FIG. 5 are described as follows.

In some embodiments, an initiating/responding Control frame without Per recipient field, e.g., a BAR frame as ICF, carries one or more control information triples right after the current frame body, e.g., the control information is right after BAR Information field in the BAR frame. In some embodiments, an initiating/responding Control frame without Per recipient field, e.g., a new defined unicast Control frame with a new control subtype, carries one or more control information triples in the frame body. Such frame may be the initial control frame or initial responding frame.

Some implementations of BAR+BA as Initiating Control Frame and Responding Control Frame, for example, by the wireless communications system 100 depicted in FIG. 1, the multi-link (ML) communications system 200 depicted in FIG. 2, the wireless device 300 depicted in FIG. 3, the wireless device 400 depicted in FIG. 4, and/or the TXOP holder 500 and the TXOP responder(s) 580 depicted in FIG. 5 are described as follows.

One restriction could be that a BAR frame+a Multi-STA BA frame as the initial frame exchange of a TXOP (e.g., as Initiating Control Frame and Responding Control Frame) is only used when the TXOP holder is a non-AP STA (the same as STA). In some embodiments, the BAR frame is a compressed BAR frame with the required updating.

In some embodiments, if a BAR frame and a Multi-STA BA frame are used in the first frame exchange for the TXOP (e.g., as Initiating Control Frame and Responding Control Frame), the following functionalities needs to be added/changed in the BAR frame, the Multi-STA BA frame besides carrying the dynamic control information:
the BAR frame carries the indication about whether the TXOP responder needs to check the medium busy/idle status when transmitting the responding frame;
the BAR frame carries the indication about whether the TXOP responder needs to perform dynamic BW negotiation; and
the BAR frame carries the indication about whether the responding STA needs to switch from a low-capacity listening mode to a high-capacity listening mode. In some embodiments, in one variant, such indication is implicit, e.g., when the PPDU carrying the BAR frame is 20 MHz, when the padding in the soliciting BAR, when the BAR frame does not carry pre-padding frame check sequence (FCS) or when the Duration field of the BAR frame is less than a threshold, the responding does not need to switch to high-capacity mode.

In some embodiments, the BAR Information field may carry no useful information or is not carried in the BAR frame if the BAR frame is not used for soliciting the acknowledgement information for any frames. The BAR Control field can carry the related indication explicitly through using the current reserved bits.

In some embodiments, the Multi-STA BA frame will not (or as another variant, may not) carry the Per AID TID Info field to acknowledge whether the frames in A-MPDU are received correctly or not, or reserved if the BAR frame does not solicit the acknowledgement information for any frames in the A-MPDU. In some embodiments, the BA Control field can carry the related indication explicitly through using the current reserved bits.

In some embodiments, the new behavior of a neighbor device (AP/STA), such as, a basic Network Allocation Vector (NAV) timer operation is described as follows. In some embodiments, an AP/STA resets the basic (inter-BSS) NAV timer to 0 when the following are true:
the basic NAV timer is set by a BAR frame from a neighbor BSS that requires the responder checks Clear Channel Assessment (CCA) before transmitting the solicited BA frame; and
the AP/STA does not detect anyone of the solicited Multi-STA BA frame and the following frame by the transmitter of the BAR frame before the specific timer times out.

In some embodiments, the BA frame length is different based on the content being carried and the padding requirement. In some embodiments, in order for an AP/STA to figure out the time (initial value to be set to the specific timer) to decide whether the BAR frame's transmitter does not transmit the frame following the BAR frame+Multi-STA BA frame exchange, the BAR frame can carry the length (is us or octets) of the PPDU carrying the solicited BA frame. In some embodiments, the length of the PPDU is decided based on the solicited control information, padding length.

Some implementations of a BSRP Trigger frame+a Multi-STA BA frame as Initiating Control Frame and Responding Control Frame, for example, by the wireless communications system 100 depicted in FIG. 1, the multi-link (ML) communications system 200 depicted in FIG. 2, the wireless device 300 depicted in FIG. 3, the wireless device 400 depicted in FIG. 4, and/or the TXOP holder 500 and the TXOP responder(s) 580 depicted in FIG. 5 are described as follows.

In some embodiments, the BSRP Trigger frame+Multi-STA BA frame as the initial frame exchange of a TXOP is used when the TXOP holder is AP or a STA (or client STA, non-AP STA accurately). The BSRP Trigger frame can indicate whether the responding Multi-STA BA frame is in non-HT PPDU when the BSRP Trigger frame solicits the Multi-STA BA frame from a single recipient. In some embodiments, when multiple Multi-STA BA frames are solicited from the STAs, the responding PPDU is a trigger based (TB) PPDU. In some embodiments, in another variant, a new defined unicast control frame with the new control subtype is used to replace the Multi-STA BA frame (BSRP Trigger frame+new defined control frame). In some embodiments, in another variant, a new defined Trigger frame is used to replace BSRP/Multi-User (MU)-RTS Trigger frame (New type of Trigger frame+Multi-STA BA frame). In some embodiments, in another variant, a QoS Null frame is used to replace the Multi-STA BA frame (e.g., the BSRP Trigger frame+the QoS Null frame). In some embodiments, the BSRP Trigger+Multi-STA BA frame, BSRP Trigger+new defined Control frame, or new Trigger frame+new defined Control frame is used as the initial frame exchange for the radio switch (RF chain switch) of EMLSR/Enhanced Multi-link Multi-radio (EMLMR) non-AP MLD.

In some embodiments, when/if a BSRP Trigger frame+a Multi-STA BA frame are used in the first frame exchange for a TXOP, the following functionalities needs to be added/changed in the BSRP Trigger frame, the Multi-STA BA frame besides carrying the dynamic control information. In some embodiments, the BSRP Trigger frame carries the indication about whether the TXOP responder needs to perform dynamic BW negotiation. In some embodiments, the BSRP Trigger frame carries the indication about whether the responding STA needs to switch from low-capacity listening mode to high-capacity listening mode. In some embodiments, in one variant, such indication is implicit, e.g., when the PPDU carrying the BSRP Trigger frame is 20 MHz, when the padding in the soliciting BSRP Trigger frame, when the BSRP Trigger frame does not carry pre-padding FCS or when the Duration field of the BSRP Trigger frame is less than a threshold, the responding does not need to switch to high-capacity mode. In some embodiments, the Multi-STA BA frame being as initial control frame solicited by the BSRP Trigger frame will not carry the Per AID TID Info field for acknowledging the A-MPDU(s). The BA Control field can carry the related indication explicitly through using the current reserved bits being repurposed.

In some embodiments, the new behavior of a neighbor device (AP/STA), such as, a basic NAV timer operation is described as follows. In some embodiments, an AP/STA reset the basic (inter-BSS) NAV timer to 0 when the following are true:
the basic NAV timer is set by a BSRP Trigger frame from a neighbor BSS that requires the responder checks CCA before transmitting the solicited Multi-STA BA frame; and
the AP/STA does not detect anyone of the solicited Multi-STA BA frame and the following frame by the transmitter of the BSRP Trigger frame before the specific timer times out. In some embodiments, the PPDU length carrying the Multi-STA BA frame is different based on the content being carried and the padding requirement. In some embodiments, in order for an AP/STA to figure out the time (initial value to be set to the specific timer) to decide whether the BSRP Trigger frame's transmitter does not transmit the frame following the BSRP Trigger frame+Multi-STA BA frame exchange, the BSRP Trigger frame can carry the length (is us or octets) of the PPDU carrying the solicited Multi-STA BA frame. In some embodiments, the length of the PPDU is decided based on the solicited control information, padding length.

Some implementations of MU-RTS frame+CTS frame as Initiating Control Frame and Responding Control Frame, for example, by the wireless communications system 100 depicted in FIG. 1, the multi-link (ML) communications system 200 depicted in FIG. 2, the wireless device 300 depicted in FIG. 3, the wireless device 400 depicted in FIG. 4, and/or the TXOP holder 500 and the TXOP responder(s) 580 depicted in FIG. 5 are described. In some embodiments, the MU-RTS frame+CTS frame or BSRP Trigger frame+QoS Null frame is used when the TXOP holder does not send the feedback (available time and unavailable time), e.g., only requests the TXOP responder(s) to switch from the low-capacity mode to the high-capacity mode. In some embodiments, the reserved bits in User Info field in the MU-RTS frame can be used to carry the Rx parameters that the TXOP holder will use for the frame exchanges with the TXOP responder.

Some implementations of multi-STA BA frame additional rules, for example, by the wireless communications system 100 depicted in FIG. 1, the multi-link (ML) communications system 200 depicted in FIG. 2, the wireless device 300 depicted in FIG. 3, the wireless device 400 depicted in FIG. 4, and/or the TXOP holder 500 and the TXOP responder(s) 580 depicted in FIG. 5 are described.

A Per AID-TID Info field in a Multi-STA BA frame may have the different BA bitmap lengths, i.e., 32 bits, 64 bits, 128 bits, 256 bits, 512 bits, 1024 bits. The selection of the Dynamic Control Per AID-TID Info field with the specific length of BA Bitmap field being repurposed to carry the dynamic control information should be defined. Otherwise, the unnecessary fragmentation, unnecessary longer Multi-STA BA frame may be used.

In some embodiments, in Option 1, each type of dynamic control information is carried in one Dynamic Control Per AID TID Info field with minimal length and enough room to carry the information. In some embodiments, the AID11 subfield of the Dynamic Control Per AID TID Info field has a specific value to indicate the type of the carried dynamic control information. The Block Ack Bitmap field of Dynamic Control Per AID TID Info field may be repurposed to carry the dynamic control information.

In some embodiments, in Option 2, each type of dynamic control information is carried in one Dynamic Control Per AID TID Info field with minimal length and enough room to carry the information. In some embodiments, the type ID is carried in TID field (repurpose TID field) or in Block Ack Bitmap field (repurpose Block Ack Bitmap to carry the dynamic control information).

In some embodiments, in Option 3 if one Dynamic Control Per AID TID Info cannot carry one type of dynamic control information for a single-addressed STA or for multiple addressed STAs, e.g., more than 1024 bits, to select Per AID-TID Info field for carrying the control information-carrying the control information of length LENGTH with the smallest number of Per AID-TID Info fields:

Set L=LENGTH;
if L is more than 1024, then one longest Dynamic Control Per AID-TID Info field with 1024-bit BA bitmap is selected to carry the first 1024 bits of the control information and sets L=L-1024, this step is repeated until L is not more than 1024, if L is 0, stop;
if L is no more than 1024, then one shortest Dynamic Control Per AID-TID Info field whose BA bitmap length is more than L is selected to carry the (remaining) control information. In some embodiments, in one variant, a Dynamic Control Per AID-TID Info field with longer length can be used where the unused bits in BA bitmap is used as part of the padding.

FIG. 7 illustrates a Dynamic Control Per AID RID Info field format 760 in accordance with an embodiment of the invention. The Dynamic Control Per AID RID Info field format 760 illustrated in FIG. 7 can be used for communications by the wireless communications system 100 depicted in FIG. 1, the multi-link (ML) communications system 200 depicted in FIG. 2, the wireless device 300 depicted in FIG. 3, the wireless device 400 depicted in FIG. 4, and/or the TXOP holder 500 and the TXOP responder(s) 580 depicted in FIG. 5. In the embodiment depicted in FIG. 7, the Dynamic Control Per AID RID Info field format 760 includes an AID TID Info field 762 (e.g., two-octet) that may contain AID TID information, a Block Ack Starting Sequence control field 764 (e.g., zero or two-octet) that may contain block ack starting sequence control information, and a control information field 766 (e.g., four-octet, eight-octet, sixteen-octet, or thirty-two-octet) that may contain feedback information or the other dynamic control information.

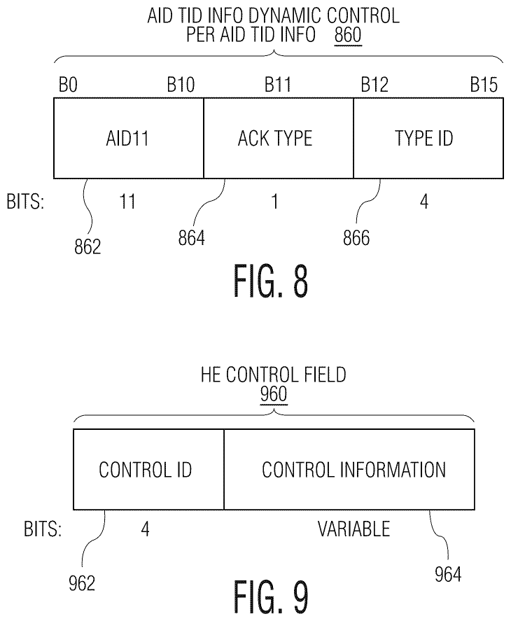

FIG. 8 illustrates an AID TID Info field format 860 of a Dynamic Control Per AID RID Info field (e.g., the Dynamic Control Per AID RID Info field 760 depicted in FIG. 7) in accordance with an embodiment of the invention. The AID TID Info field format 860 illustrated in FIG. 8 can be used for communications by the wireless communications system 100 depicted in FIG. 1, the multi-link (ML) communications system 200 depicted in FIG. 2, the wireless device 300 depicted in FIG. 3, the wireless device 400 depicted in FIG. 4, and/or the TXOP holder 500 and the TXOP responder(s) 580 depicted in FIG. 5. In the embodiment depicted in FIG. 8, the AID TID Info field format 860 includes an AID11 field 862 (e.g., eleven-octet) that may contain AID information, an Ack Type field 864 (e.g., one-octet) that may contain Ack Type information where the Ack Type in Dynamic Control Per AID TID Info field always indicates the Block Ack context, and a Type ID field 866 (e.g., four-octet) that may contain Type ID information. In some embodiments, the AID TID Info field format 860 contains one or more additional fields with additional information. In some embodiments, the Type ID field 866 in a Dynamic Control Per AID TID Info field does not exist where the related bits are reserved when AID11 subfield of the Per AID TID Info field carries the type information of the dynamic control information.

In some embodiments, in Option 3 of the rules, to select Per AID-TID Info field for carrying the control information—carrying the control information of length LENGTH with the smallest aggregated BA bitmap of Per AID-TID Info fields:

Set L=LENGTH;
if L is more than 1024, then one longest Dynamic Control Per AID-TID Info field with 1024-bit BA bitmap is selected to carry the first 1024 bits of the control information and sets L=L-1024, this step is repeated until L is not more than 1024, if L is 0, stop;
if L is no more than 1024, and one shortest Dynamic Control Per AID-TID Info field (Per AID-TID Info field1) whose BA bitmap length is no less than L has BA bitmap length L1.

In some embodiments, if two Dynamic Control Per AID-TID Info fields whose aggregated BA bitmap length is no less than L and is less than L1 (the BA bitmap length of Dynamic Control Per AID-TID Info field1) can be found, the Dynamic Control Per AID-TID Info fields are used to carry the (remaining) control information. Otherwise, if two Dynamic Control Per AID-TID Info fields whose aggregated BA bitmap length is no less than L and is same as L1 (the BA bitmap length of Per Dynamic Control AID-TID Info field1) can be found, Dynamic Control Per AID-TID Info field1 is used to carry the (remaining) control information.

Some implementations of HT Control Field with Variable Length, for example, by the wireless communications system 100 depicted in FIG. 1, the multi-link (ML) communications system 200 depicted in FIG. 2, the wireless device 300 depicted in FIG. 3, the wireless device 400 depicted in FIG. 4, and/or the TXOP holder 500 and the TXOP responder 580 depicted in FIG. 5 are described. In some embodiments, the 4-octet HT Control field in a QoS Null frame is not enough to carry the various kinds of control information. In some embodiments, one improvement is that in the QoS Null frame used for carrying various control information the HE Control field can have variable length that is longer enough to carry all the required control information.

FIG. 9 illustrates a HE control field format 960 in a Dynamic Control Per AID TID Info field in accordance with an embodiment of the invention. The HE control field format 960 illustrated in FIG. 9 can be used for communications by the wireless communications system 100 depicted in FIG. 1, the multi-link (ML) communications system 200 depicted in FIG. 2, the wireless device 300 depicted in FIG. 3, the wireless device 400 depicted in FIG. 4, and/or the TXOP holder 500 and the TXOP responder 580 depicted in FIG. 5. In the embodiment depicted in FIG. 9, the HE control field format 960 includes a control ID field 962 (e.g., four-octet) that may contain control ID information and a control information field 964 (e.g., variable) that may contain control information. In some embodiments, the HE control field format 960 contains one or more additional fields with additional information.

Some implementations of TXOP duration decided by TXOP responder(s), for example, by the wireless communications system 100 depicted in FIG. 1, the multi-link (ML) communications system 200 depicted in FIG. 2, the wireless device 300 depicted in FIG. 3, the wireless device 400 depicted in FIG. 4, and/or the TXOP holder 500 and the TXOP responder 580 depicted in FIG. 5 are described. In some embodiments, when the Duration field of the responding frame carries the TXOP responder's available time of the TXOP and the responding frame is in TB PPDU, two TXOP responders transmit the responding frames with the different available time in the same 20 MHz channel will set the different values in the same field of the PHY header to carry the TXOP duration. In some embodiments, to address such issue, the PHY header indicates the UNSPECIFIED value.

In some embodiments, a method of designing a control frame between a first wireless device and a second wireless devices to flexibly carrying various control information where the control frame includes, but not limited to, in-device co-existence, power save, Tx/Rx parameter negotiation, the method involves announcing, by the first wireless device and the second wireless device in a TXOP, various control information in the first frame exchange of a TXOP and conducting the frame exchanges, by the first wireless device and the second wireless device in the TXOP, per the announced control information. In some embodiments, the method further includes when initiated by an AP, the initiating frame in the first frame exchange is used to solicit the radio switch of a non-AP MLD with which the addressed STA in an EMLSR/EMLMR link by the first initiating frame is affiliated. In some embodiments, the initiating frame in the first frame exchange is used to indicate whether the responding device needs to perform Clear Channel Assessment (CCA) before transmitting the responding frame of the first frame exchange. In some embodiments, the initiating frame in the first frame exchange is used to indicate whether the responding device needs to perform dynamic BW negotiation. In some embodiments, the initiating frame in the first frame exchange is used to indicate whether the responding device needs to switch from the low-capacity listening mode to high-capacity mode. In some embodiments, the initiating frame in the first frame exchange is BSRP Trigger and the responding frame in the first frame exchange is Multi-STA BA. In some embodiments, the Multi-STA BA transmitted by a STA is carried in non-HT duplicate PPDU. In some embodiments, the initiating frame in the first frame exchange is BSRP Trigger and the responding frame in the first frame exchange is a defined Control frame. In some embodiments, the new defined control frame transmitted by a STA is carried in non-HT duplicate PPDU.

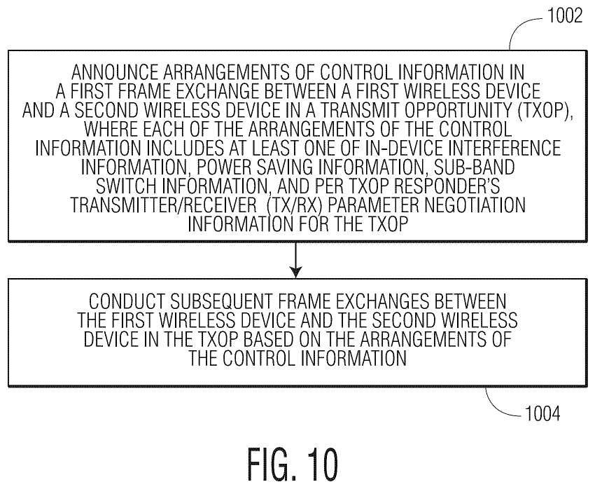

FIG. 10 is a process flow diagram of a method for wireless communications in accordance with an embodiment of the invention. At block 1002, arrangements of control information are announced in a first frame exchange between a first wireless device and a second wireless device in a transmit opportunity (TXOP), where each of the arrangements of the control information includes at least one of in-device interference information, power saving information, sub-band switch information, and per TXOP responder's transmitter/receiver (Tx/Rx) parameter negotiation information for the TXOP. At block 1004, subsequent frame exchanges are conducted between the first wireless device and the second wireless device in the TXOP based on the arrangements of the control information. The wireless device may be the same as or similar to an embodiment of the AP 106 depicted in FIG. 1, the STA 110-1, . . . , 110-n depicted in FIG. 1, the APs 206-1, 206-2 depicted in FIG. 2, the STAs 210-1, 210-2 depicted in FIG. 2, the wireless device 300 depicted in FIG. 3, the wireless device 400 depicted in FIG. 4, and/or the TX holder 500 depicted in FIG. 5. The second wireless device may be the same as or similar to an embodiment of the AP 106 depicted in FIG. 1, the STA 110-1, . . . , 110-n depicted in FIG. 1, the APs 206-1, 206-2 depicted in FIG. 2, the STAs 210-1, 210-2 depicted in FIG. 2, the wireless device 300 depicted in FIG. 3, the wireless device 400 depicted in FIG. 4, and/or the TX responder 580 depicted in FIG. 5.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods described herein may be implemented using software instructions stored on a computer useable storage medium for execution by a computer. As an example, an embodiment of a computer program product includes a computer useable storage medium to store a computer readable program.

The computer-useable or computer-readable storage medium can be an electronic, magnetic, optical, electromagnetic, infrared, or semiconductor system (or apparatus or device). Examples of non-transitory computer-useable and computer-readable storage media include a semiconductor or solid-state memory, magnetic tape, a removable computer diskette, a random-access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Alternatively, embodiments of the invention may be implemented entirely in hardware or in an implementation containing both hardware and software elements. In embodiments which use software, the software may include but is not limited to firmware, resident software, microcode, etc.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A wireless device comprising:
a controller configured to determine an arrangement of control information; and
a wireless transceiver configured to announce the arrangement of the control information in a first frame exchange with a second wireless device in a transmit opportunity (TXOP) and to conduct a plurality of subsequent frame exchanges with the second wireless device based on the arrangement of the control information.

2. The wireless device of claim 1, wherein the arrangement of the control information comprises at least one of in-device interference information, power saving information, sub-band switch information, and per TXOP responder's transmitter/receiver (Tx/Rx) parameter negotiation information for the TXOP.

3. The wireless device of claim 2, wherein per TXOP responder's transmitter/receiver (Tx/Rx) parameters for different TXOP responders are different.

4. The wireless device of claim 1, wherein the controller is further configured to generate an initiating control frame that comprises the arrangement of the control information.

5. The wireless device of claim 1, wherein the arrangement of the control information comprises a control information triple, and wherein the control information triple comprises type information, length information, and content information.

6. The wireless device of claim 1, wherein the arrangement of the control information comprises a control information pair, and wherein the control information pair comprises type information and content information.

7. The wireless device of claim 1, wherein the wireless transceiver is further configured to:
receive a second arrangement of the control information from the second wireless device in the first frame exchange with the second wireless device in the TXOP; and
conduct the subsequent frame exchanges with the second wireless device in the TXOP based on the arrangement of the control information and the second arrangement of the control information.

8. The wireless device of claim 7, wherein the controller is further configured to generate an initiating control frame that contains the arrangement of the control information, and wherein the wireless transceiver is further configured to receive, from the second wireless device, a responding control frame that contains the second arrangement of the control information.

9. The wireless device of claim 8, wherein the initiating control frame comprises a Buffer Status Report Poll (BSRP) trigger frame, and wherein the responding control frame comprises a multi-station (multi-STA) block acknowledgement (BA) frame.

10. The wireless device of claim 9, wherein the BSRP trigger frame contains information that indicates whether the Multi-STA BA frame is contained in a non-High Throughput (HT) Physical Layer Protocol Data Unit (PPDU) when the BSRP trigger frame solicits the Multi-STA BA frame from a single recipient.

11. The wireless device of claim 9, wherein the Multi-STA BA frame does not carry a BA bitmap for acknowledging an Aggregate MAC Protocol Data Unit (A-MPDU).

12. The wireless device of claim 9, wherein the Multi-STA BA frame comprises a Per Association ID (AID) Traffic Identifier (TID) information (Info) field for all addressed or associated stations (STAs).

13. The wireless device of claim 8, wherein the initiating control frame comprises a block acknowledgement response (BAR) frame, and wherein the responding control frame comprises a block acknowledgement (BA) frame.

14. The wireless device of claim 8, wherein the initiating control frame comprises a multi-user-request to send (MU-RTS) frame, wherein the responding control frame comprises a clear to send (CTS) frame, and wherein a TXOP holder of the TXOP does not send feedback information.

15. The wireless device of claim 8, wherein the initiating control frame comprises a Buffer Status Report Poll (BSRP) trigger frame, wherein the responding control frame comprises a quality of service (QOS) null frame, and wherein a TXOP holder of the TXOP does not send feedback information.

16. The wireless device of claim 8, wherein the wireless transceiver is further configured to transmit the initiating control frame to the second wireless device.

17. The wireless device of claim 8, wherein the initiating control frame comprises a special User information (Info) field for all addressed or associated stations (STAs).

18. The wireless device of claim 1, wherein the wireless device comprises a mobile wireless access point (AP) or a wireless non-AP station (STA).

19. A wireless access point (AP) compatible with an Institute of Electrical and Electronics Engineers (IEEE) 802.11 protocol, the wireless AP comprising:
a controller configured to determine an arrangement of control information; and
a wireless transceiver configured to announce the arrangement of the control information in a first frame exchange with a wireless station (STA) device in a transmit opportunity (TXOP) and to conduct a plurality of subsequent frame exchanges with the wireless STA device in the TXOP based on the arrangement of the control information.

20. A method for wireless communications, the method comprising:
announcing a plurality of arrangements of control information in a first frame exchange between a first wireless device and a second wireless device in a transmit opportunity (TXOP), wherein each of the arrangements of the control information comprises at least one of in-device interference information, power saving information, sub-band switch information, and per TXOP responder's transmitter/receiver (Tx/Rx) parameter negotiation information for the TXOP; and
conducting a plurality of subsequent frame exchanges between the first wireless device and the second wireless device in the TXOP based on the arrangements of the control information.
